(19) United States
(12) Patent Application Publication
(10) Pub. No.: US 2009/0162941 A1
(43) Pub. Date: Jun. 25, 2009

(54) Methods and Devices, Including Stoppers Comprising an Internal Recess with Particular Hydrophilicity Characteristics, for Limiting Air Ingestion During Sample Extraction

(76) Inventors: James Winkler, San Diego, CA (US); Robyn Bennis, Mountain View, CA (US); Lou Dietz, Mountain view, CA (US); Keith Moravick, Mountain View, CA (US); Haile Negussie, Mountain View, CA (US)

Correspondence Address: WILSON SONSINI GOODRICH & ROSATI, 650 PAGE MILL ROAD, PALO ALTO, CA, 94304-1050, US

(21) Appl. No.: 11/963,320

(22) Filed: Dec. 21, 2007

(51) Int. Cl. B65D 39/04; G01N 1/10

(52) U.S. Cl. 436/180; 215/355

(57) ABSTRACT

The present invention relates to methods and devices for air ingestion prevention. The invention provides a stopper or plug with one or more conduits and a recess that prevents air ingestion during outlet of a liquid from a liquid container covered with the stopper.

### BACKGROUND

Liquid samples are routinely stored in sample containers, where samples may be taken from the containers for multiple purposes, for example, for analysis for research or diagnostic purposes. Typically, sample containers are covered, for example with caps, plugs, or stoppers, for storage and prevention of sample loss or contamination. Samples may also be capped to prevent accidental spills of hazardous liquids. However, samples routinely withdrawn from capped sample containers can introduce unwanted air into the outlet tube or conduit, thereby preventing efficient transfer of valuable samples, contributing to contamination, sample loss, and sample handlers' risks. Thus, there exists a need for methods and devices for preventing ingestion of air into outlet tubes and conduits.

When processing a sample with cells or particulates over a period of time, it is often necessary to rock or otherwise agitate the sample to keep the cells or particulates in solution. In order to do this in the most gentle and efficient fashion, rocking or inversion of the sample container is often employed. However, when the sample container is inverted, the system is likely to draw air into the flow path, often with deleterious effects to the process. Disclosed herein are devices and methods of preventing ingestion of air while keeping cells or other particulates suspended in solution.

### INCORPORATION BY REFERENCE

All publications and patent applications mentioned in this specification are herein incorporated by reference to the same extent as if each individual publication or patent application was specifically and individually indicated to be incorporated by reference.

### SUMMARY OF THE INVENTION

The invention herein involves methods and devices for preventing air ingestion into samples which are being extracted from a sample container. The present invention is especially useful when the sample contains cells and/or particulates which may settle if the sample is not agitated during extraction from the sample container.

One embodiment of the present invention is a stopper for a container for liquids which has a top surface and a bottom surface, wherein the bottom surface has a recessed area that is hydrophobic or hydrophilic and also has a first conduit that extends from the top surface to the recessed area. The first conduit may be configured to allow an outlet rate of at least 0.01 μl per second. In some instances, the recessed area is at least 25% of the length of the stopper diameter. Some stoppers of the present invention have an orientation-maintaining feature located on the top surface. This orientation-maintaining feature may cause the recessed area to be maintained in a vertical position when the stopper is placed on a flat surface. The stoppers of the present invention may also comprise an air-tight seal

Other stoppers of the present invention comprise a second conduit which extends from the top surface to the bottom surface. The second conduit of such stoppers typically extends to an area of the bottom surface not within the recessed area. The second conduit may be connected to a pump and/or may allow a gas to enter the sample container. Examples of gasses which may enter the sample container through the second conduit include, atmospheric air, nitrogen, carbon dioxide, oxygen, oxygen-nitrogen mixtures, helium, helium-oxygen mixtures, and combinations thereof.

The first conduit of the stoppers of the present invention may have an interior surface which is hydrophobic or hydrophilic. Typically, the hydrophilicity character of the interior surface will correspond to the hydrophilicity character of the recessed area. Additionally, some stoppers may have a tube connected with the first conduit, wherein the tube does not extend into the container further than the recessed area. In some stoppers, the first conduit is proximal to the periphery of the stopper. The first conduit may be connected to a vacuum.

One method disclosed herein is a method of withdrawing a sample from a container involving the steps of: 1) placing a stopper in the sample container where the stopper has a top and bottom surface, and the bottom surface has a recessed area that is hydrophilic or hydrophobic and has a first conduit that extends from the top surface to the recessed area; and 2) limiting access of air into the first conduit in the stopper by maintaining liquid at the first conduit on the bottom surface. In some instances, the limiting step is enhanced by hydrophilic or hydrophobic attraction between the recessed area and the liquid.

The stoppers utilized for this method may have a second conduit that extends from the top surface to the bottom surface. The second conduit may be connected to a pump and/or have gasses, including atmospheric air, nitrogen, carbon dioxide, oxygen, oxygen-nitrogen mixtures, helium, helium-oxygen mixtures, and combinations thereof, inserted through the second conduit. The stoppers may also have an orientation-maintaining feature on the top surface. In some instances the orientation-maintaining feature will maintain the recessed area in a vertical position when placed on a flat surface. The stoppers may also have a tube fluidly connected with the first conduit and the tube may also fluidly connect to an analytical device. The first conduit of the stopper may be connected to a vacuum and/or may be located proximal to the periphery of the stopper.

Another aspect of the present invention is a method of withdrawing a sample from a sample container comprising the steps of: 1) placing a stopper in the sample container where the stopper has a top and bottom surface, and the bottom surface has a recessed area that is hydrophilic or hydrophobic and has a first conduit that extends from the top surface to the recessed area; 2) placing the sample container on a rocker, where the rocker is capable of causing at least a portion of the sample to be drawn away from the stopper by gravity; and 3) limiting access of air into the first conduit in the stopper by maintaining liquid at the first conduit on the bottom surface. In some instances, the limiting step of this method is enhanced by hydrophilic or hydrophobic attraction between the recessed area and the liquid. In other instances, the limiting step occurs when at least a portion of the sample is drawn away from the stopper by gravity.

The stoppers utilized for this method may have a second conduit that extends from the top surface to the bottom surface. The second conduit may be connected to a pump and/or have gasses, including atmospheric air, nitrogen, carbon dioxide, oxygen, oxygen-nitrogen mixtures, helium, helium-oxygen mixtures, and combinations thereof, inserted through the second conduit. The stoppers may also have an orientation-maintaining feature on the top surface. In some instances the orientation-maintaining feature will maintain the recessed area in a vertical position when placed on a flat surface. The stoppers may also have a tube fluidly connected with the first conduit and the tube may also fluidly connect to an analytical device. The first conduit of the stopper may be connected to a vacuum and/or may be located proximal to the periphery of the stopper.

### SUMMARY OF THE FIGURES

FIG. 1 is a schematic diagram of a stopper with two conduits through the stopper and a recessed area on the interior surface.

FIG. 2 is a schematic diagram of a stopper and a sample tube. The stopper has a flat surface for maintaining position of a recessed area on the interior surface of the stopper.

FIG. 3 is a schematic diagram of a stopper and a sample tube on a rocker platform.

FIG. 4 is a schematic diagram of a stopper with two conduits and a recessed area on the interior surface of the stopper.

FIG. 5 is a schematic diagram of the different surfaces on the interior portion of a stopper.

FIG. 6 is a schematic diagram focusing on the exterior portion of a stopper, showing orientation-maintaining features.

### DETAILED DESCRIPTION OF INVENTION

The present invention relates to devices that prevent ingestion of air by liquid outlet tubes or conduits. In another aspect of the present invention, methods of preventing ingestion of air by liquid outlet tubes or conduits are provided. The methods and stoppers of the present invention, utilize design features in the stopper of a sample holding tube to prevent ingestion of gasses and/or air while keeping cells and/or particulates gently suspended in solution for a long period of time (e.g., minutes, hours, days). The methods and stoppers of the present invention are particularly useful in any flow system used to study cells.

Liquid samples are routinely stored in sample containers, where samples may be taken from the containers for multiple purposes, for example, for analysis for research or diagnostic purposes. Liquids stored include hydrophilic or hydrophobic fluids, such as water or oils. Samples may include environmental samples, for example, salt water samples, fresh water samples, reservoir water samples, waste treatment samples, rain water samples, and liquid samples of unknown origin. Samples may include liquids such as biological fluids, for example, whole blood, sweat, tears, ear flow, sputum, lymph, bone marrow suspension, urine, saliva, semen, vaginal flow, cerebrospinal fluid, brain fluid, ascites, milk, secretions of the respiratory, intestinal or genitourinary tracts fluid. In some embodiments, particulates (e.g., cells) may be suspended in a suitable buffer or organic/inorganic salts dissolved in water. Samples may be in liter, deciliter, centiliter, milliliter, microliter, or nanoliter quantities.

Sample containers include sample tubes, collection tubes, culture tubes, flasks, and other liquid handling devices or containers. The sample containers may be glass, plastic, metal or other suitable materials. The sample containers may be coated or contain a reagent. For example, blood collection tubes may be glass tubes coated with or containing anticoagulants such as EDTA, citrate, or heparin. Another type of blood collection tube is a tube with a partial vacuum, such as the Vacutainer (Becton Dickinson).

Typically, sample containers are covered, for example with caps, plugs, stoppers and the like, for storage and prevention of sample loss or contamination. Samples may also be capped to prevent hazardous risks to the people handling the samples. For example, samples may comprise a hazardous or potentially hazardous liquid, such as phenol, a highly infectious agent, or a biological sample, such as blood.

Samples withdrawn from capped liquid sample containers generally introduce unwanted gasses and/or air into the tube used to withdraw the liquid (i.e., an outlet tube) or the conduits of the cap or stopper, especially when the sample container is being rocked to prevent settling of cellular and/or particulate components. For example, when an outlet tube or the like is used to withdraw a liquid sample from a closed sample container which is being rocked, the outlet tube is occasionally not submerged or in contact with the liquid sample. This typically causes introduction of air into the outlet tube and conduit, which may prevent efficient sample outlet and/or promote sample loss, sample contamination and/or contamination risk to the handlers of the liquids. The present invention provides a stopper that may ameliorate these issues with sample outlet.

The stoppers of the invention disclosed herein may comprise plastic, metal, rubber, or silicon. Alternately, the stopper may comprise a synthetic resin type or natural or synthetic rubber type compound and/or may comprise butyl rubber (IIR) 80, ethylene-propylene type copolymer (EPT), sulfur, zinc white, vulcanization accelerator (TL), zinc dibutyl dithiocarbamate (BZ), kaolin clay, a highly water absorbable macromolecular compound, polyisobutylene 35 parts by weight, partially cross-linked butyl rubber, 1,2-Polybutadiene, mica, talc, silicone oil, liquid paraffin, antioxidant, styrene-butadiene-styrene, thermoplastic elastomer (SBS), polypropylene copolymer, isobutylene-isoprene copolymers (IIR), chlorinated isobutylene-isoprene copolymers (C-IIR), brominated isobutylene-isoprene copolymers (B-IIR), crosslinked isobutylene-isoprene-divinylbenzene ternary copolymers (XL-IIR) and brominated isobutylene-para-methystyrene copolymers (BIMS), C-IIR (such as Esso Butyl HT 1066), high density polyethylene powder (such as Millason 68P), styrene-ethylene-butylene-styrene thermoplastic rubber (such as G1650), magnesium oxide (such as Kyowa-Mag® 150), of s-triazine, chlorinated butyl rubber, Bayer Butyl XL-10000, isoprene-isobutylene-divinylbenzene ternary copolymer crosslinked butyl rubber, Esso Butyl 365, isoprene-isobutylene copolymer type butyl rubber, Nipsil VN-3, wet process silica, White Tex Clay #2, Mipelon® 220, ultrahigh molecular weight polyethylene resin fine powder, Mirason® 68P, high density polyethylene resin pellets, Kraton® G1650, styrene-ethylene-butylene-styrene thermoplastic rubber, Tipaque® A100, titanium dioxide of anatase type, Therm Black® MT, medium thermal carbon black, commercial name, Kyowa-Mag® 150, active magnesium oxide, commercial name, JIS Standard, first class zinc oxide, Lunac S30, stearic acid, commercial name, Nocceler® TRA, dipentamethylenethiuram tetrasulfide, commercial name, Accel BZ, zinc dibutyldithiocarbamate, Zisnet DB, 2-di-n-butylamino-4,6-dimercapto-s-triazine, commercial name, Sumifine BM, N,N′-m-phenylenebismaleimide, TAIC, triallyl isocyanurate, commercial name, fine powder sulfur, and Perhexa 2.5 B 100% Product, 2,5-dimethyl-2,5-bis-(t-butylperoxy)hexane.

It will be understood that for any given component described herein, any of the possible candidates or alternatives listed for that component, may generally be used individually or in any combination with one another, unless implicitly or explicitly understood or stated otherwise.

The stoppers of the present invention may also comprise one or more layers on the surface of the stopper. Such layers may impart a hydrophobic or hydrophilic character to the surface which they cover. Some stoppers may comprise more than one layer, such as a laminate of multiple layers. Any or all of the layers may be photo-polymerizable.

The stoppers of the present invention are designed to work with any commercially available test tube, such as a 50 ml, 25 ml, 15 ml, 10 ml, 7 ml, 5 ml, 3 ml, 2 ml or 1 ml test tube. The stoppers are designed to work with sample containers other than a sample tube, such as larger volume sample containers, which provides access to the sample contained in the sample container, e.g., an Erlenmeyer flask. As will be apparent to one of skill in the art, stoppers of the present invention are designed to fit a sample container with an opening other than a round opening, such as a square, triangular, pentagonal, octagonal, oval or rectangular opening.

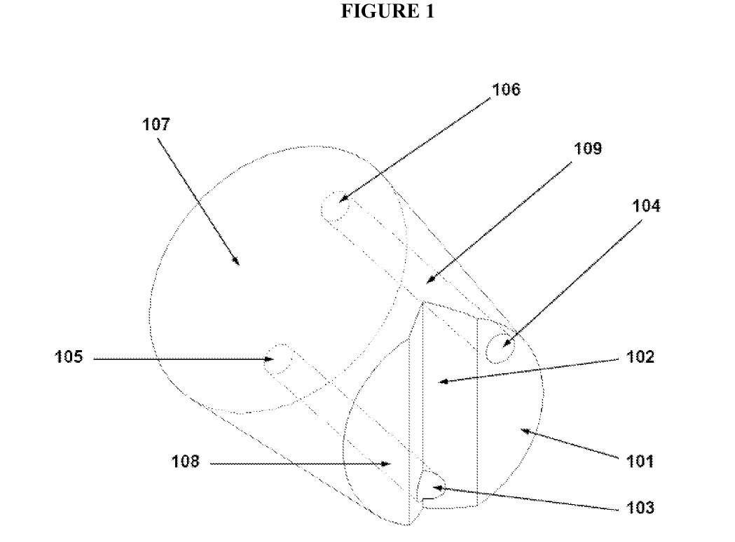

One embodiment of the present invention is shown in FIG. 1. The stopper in FIG. 1 has an external surface (107) which is external to the tube or other container into which it is inserted. The stopper also has an internal surface (101) which is internal to the tube or other container into which it is inserted. The internal surface is at least in part recessed (102). The stopper comprises an outflow conduit (108) configured for removal of fluid from the container. The outflow conduit comprises an opening (103) on the internal surface as well as a conduit (105) on the external surface. The internal opening (103) of the outflow conduit is located within the recessed area (102). As is clear from the diagram, the conduit extends through the body of the stopper and is continuous from the external surface (107) to the internal surface (101).

The stopper can also optionally comprise a second conduit (109). The second conduit comprises an opening (104) on the internal surface as well as an opening (106) on the external surface. The inlet conduit (109) may be utilized to introduce one or more fluids (such as reagents, buffers, and gasses), compounds and/or samples into the container in which the stopper is placed. The outlet conduit (108) may be utilized to withdraw a sample from the tube or other container into which the stopper is placed. One of skill in the art will realize that the conduits of the stoppers of the present invention may function as an outlet conduit or an intake conduit at different times and/or sequentially. The conduits may have different diameters from each other or may have essentially the same diameter. Additionally, the diameter of any conduit may vary along the length of the conduit, narrowing or widening as intended by design.

The opening (103) of the outlet conduit which is on the internal surface (101) is present in a recess (102). This recess creates a channel along the interior surface (101) across the length of the stopper. The internal opening of the inlet conduit (104), when present, is not located in the recessed area. Such a configuration allows for a sample to be withdrawn from container through the outlet conduit, while simultaneously coming into little or no contact with the inlet conduit when the sample container, for example, a test tube, is maintained in a particular position. In this embodiment, all or part of surface 101, recess 102 and/or the internal opening of the outlet conduit 103 may be hydrophilic or hydrophobic.

Typically, a liquid contained in the container, or a portion thereof, may be withdrawn from the container by any method known in the art. In some instances, a pump may be attached to the inlet conduit (109) and a liquid or gas may be introduced into the container to increase internal pressure, thus forcing the sample out through the outlet conduit (108). In other instances, a vacuum device may be attached to the outlet conduit (108) to withdraw the liquid from the container. In such instances, the inlet conduit (109) would allow air (or other gasses) to enter the container to replace the withdrawn fluid. In such embodiments, a valve, orifice, or other devices known in the art may be used to control flow and/or filter air or other gasses entering the container. In still other instances, liquid may be withdrawn from the sample container through the outlet conduit (108) by capillary action, for example, by using a bibulous membrane. In such instances, the inlet conduit (109) would allow air (or other gasses) to enter the container to replace the withdrawn fluid. In still other instances, head pressure (e.g., the liquid container is inverted such that gravity, height and/or sample density exert pressure on the inner surface of the stopper) can be used to force the liquid out of the container through the outlet conduit (108). In such instances, the inlet conduit may allow air to enter the container to replace the withdrawn fluid. Additionally, when head pressure is utilized to extract a sample from a container, a tube or other facilitating device may be inserted through the inlet conduit to facilitate continued air flow and prevent fluid outflow.

The recessed area (102) is designed to retain a quantity of a sample being withdrawn to supply the outlet conduit (108) during periods of non-submergence (e.g, a sample tube is stored with the stopper up or the sample tube is placed on a mechanical rocker). In one embodiment the recess retains a quantity of sample by hydrophobic or hydrophilic interactions between the surface of the recess and the sample. In another embodiment the recess retains a quantity of sample by van der Waals forces or by hydrogen bonding. Whether an individual recess is hydrophobic or hydrophilic will depend on the purpose to which the stopper is put, the material from which the recess of the stopper is made, and/or treatment of the recess with a hydrophilicity-affecting agent.

The stoppers of the present invention, including the stopper shown in FIG. 1, may comprise at least one hydrophilic region. Such a hydrophilic region may further be localized to at least one region on the surface of the stopper, such as in a recessed area (102) or the internal surface (101) of the stopper. Regions of the stopper may be rendered hydrophilic by making those portions out of a hydrophilic material, or by adding a compound to the stopper material during manufacture to render the stopper hydrophilic.

The recess (102) is typically hydrophilic if the sample to be withdrawn comprises water. Non-limiting examples of samples which comprise water include a bodily fluid, such as blood, urine, serum, lung aspirant, lavage fluid, amniotic fluid, sweat, tears, saliva, semen, or other bodily fluid. Samples may be an aqueous fluid comprising at least 60% water, such as 61%, 62%, 63%, 64%, 65%, 66,%, 67%, 68%, 69%, 70%, 71%, 72%, 73%, 74%, 75%, 76,%, 77%, 78%, 79%, 80%, 81%, 82%, 83%, 84%, 85%, 86,%, 87%, 88%, 89%, 90%, 91%, 92%, 93%, 94%, 95%, 96,%, 97%, 98%, 99%, 100%. Samples may also be diluted with a fluid, such as an isotonic fluid. For example the bodily fluid may be diluted with a saline solution. In another embodiment the sample may be diluted with a solution containing a compound, such as an anticoagulant (e.g. Heparin) and antibiotic or a preservative agent, such as a fixative or a nucleic acid stabilization reagent. Examples of fixatives include formaldehyde, glutaraldehyde.

In some embodiments a region of the stopper on the interior surface (101) is rendered hydrophilic by coating the stopper with a hydrophilic material. For example, the recess (102) or a opening of the outlet conduit (103) in the recessed area (102) may be coated with a hydrophobic material. Alternately, such regions may be rendered hydrophilic, for example, by treating the stopper with ionized plasma, plasma gas, fluorination treatment, coating of fluorine or silicone releasants, surface grafting of hydrophilic groups, or a corona discharge.

The stoppers of the present invention may also be entirely hydrophilic where such stoppers are constructed entirely of hydrophilic compounds. Such compounds include, but are not limited to, vinyl pyrrolidone, N-substituted or non-substituted acrylamide, acrylic acid, polyethylene glycol group-containing (meth)acrylate, hydroxyl group-containing (meth)acrylate, amino group-containing (meth)acrylate, carboxyl group-containing (meth)acrylate, phosphoric acid group-containing (meth)acrylate, sulfone group-containing (meth)acrylate, water-soluble polymer, surfactant, and inorganic powders (e.g. silica gel). In still other embodiments, the sample container, in addition to the stopper, may contain hydrophilic or hydrophobic regions.

For some applications, a hydrophobic stopper or a stopper with hydrophobic regions may be useful. Such regions may be constructed or limited as described above, except using hydrophobic compounds including, but not limited to, hydrophobizing agents (water repellents) such as silicone oil or a fluorine-substituted hydrocarbon. Thus, the recess (102) may comprise a hydrophobic surface. For example if the stopper is to be used with hydrophobic samples or samples comprising hydrophobic components, such as lipid compositions, compositions comprising fats, oils or other hydrocarbon fluids, the recess may be hydrophobic, so that the hydrophobic sample may gather by the outlet conduit. Variation in the hydrophilicity/hydrophobicity of the recess may permit separation of liquid samples based on differences in hydrophobicity. For example, a solute that has at least some hydrophobic properties or is incompletely emulsified (such as a lipid surrounded by bile salts) in an aqueous buffer may be isolated. The stopper for the sample may have a hydrophilic recess and the aqueous buffer may gather at the outlet conduit and be withdrawn, leaving the less hydrophilic sample in the container.

In some instances, all or some of the interior surface of the inlet conduit (109) of the stopper may be hydrophobic. This may be accomplished by constructing the inlet conduit from a hydrophobic material and/or inserting a hydrophobic filter (e.g., an expanded PTFE foam filter). An inlet conduit which is hydrophobic serves to prevent or diminish the amount of hydrophilic sample escape from the sample container, typically while allowing gasses into the container. One of skill in the art will recognize that the hydrophilicity character of the inlet conduit may be chosen to correspond to, or differ from, the hydrophilicity character of one or more interior surfaces (101, 102) and/or the hydrophilicity character of the sample.

Additionally, the external opening (106) of the inlet conduit may be surrounded by a reservoir or recessed area. Such a feature helps prevent sample leakage from the inlet conduit. For example, leakage may occur when, during rocking, surge pressure against the inlet conduit due to the motion of the rocker is sufficient to force liquid out of the container through the inlet conduit. In stoppers with a reservoir or recessed area surrounding the external opening, sample is typically trapped, absorbed, or otherwise retained in the vicinity of the external opening (106) of the inlet conduit. Sample leaking through the inlet conduit, but retained in the area surrounding the external opening of the inlet conduit may then be drawn back into the sample container, for example by a decrease in internal pressure in the sample container.

In some embodiments, the outlet conduit (108) is fluidly connected to an outlet tube which may be constructed of any appropriate material. Such a tube may extend through the entirety of the stopper, but typically will not extend past the interior opening (103). In some embodiments, the tube may extend into the recessed area, but will typically not extend past the interior surface (101) of the stopper. Outlet tubes may also be connected to various other tubes, devices, or reagent containers. An outlet tube may lead directly to another sample container or to an analytical device. Furthermore, an outlet tube may be connected with any system known in the art which requires delivery of a fluid medium from one container to a location outside the container. The stoppers/plugs of the present invention are especially useful for partial or substantially complete removal of a fluid sample. For example, the stoppers herein can allow for removal of more than 95%, 99%, 99.5%, 99.9% or 99.99% of a fluid sample from a sample container. The stoppers herein also allow for an automated high-throughput system for delivery of a solution to an analytical device.

The fluids passing through the outlet conduits and/or outlet tubes of the present invention may be delivered to any analytical device. Examples include, but are not limited to affinity columns, particle sorters, e.g., fluorescent activated cell sorters, capillary electrophoresis, microscopes, spectrophotometers, sample storage devices, sample preparation devices and microfluidic devices.

Exemplary analytical devices include devices useful for size, shape, or deformability based enrichment of particles, including filters, sieves, and deterministic separation devices, e.g., those described in International Publication Nos. 2004/029221 and 2004/113877, Huang et al. Science 304, 987-990 (2004), U.S. Publication No. 2004/0144651, U.S. Pat. Nos. 5,837,115 and 6,692,952, U.S. Application Nos. 60/703,833 and 60/704,067, and the U.S. application entitled “Devices and Methods for Enrichment and Alteration of Cells and Other Particles” and filed on Sep. 15, 2005; devices useful for affinity capture, e.g., those described in International Publication No. 2004/029221 and U.S. application Ser. No. 11/071,679; devices useful for preferential lysis of cells in a sample, e.g., those described in International Publication No. 2004/029221, U.S. Pat. No. 5,641,628, and U.S. Application No. 60/668,415; and devices useful for arraying cells, e.g., those described in International Publication No. 2004/029221, U.S. Pat. No. 6,692,952, and U.S. application Ser. Nos. 10/778,831 and 11/146,581. Two or more devices may be combined in series, e.g., as described in International Publication No. 2004/029221. Analytical devices may or may not include microfluidic channels, i.e., may or may not be microfluidic devices.

In another embodiment the location of the opening of the outlet conduit (103) in a stopper designed to separate out hydrophobic components from an aqueous solution may be in a different position than a stopper designed to be used with a predominately aqueous (hydrophilic) sample. For example, if a sample comprises an unemulsified solution of lipids and water then the outlet conduit may be located above the midsection of the stopper in order to increase the purity of the lipids withdrawn and to withdraw as little water as possible. This positioning makes use of the physical characteristics of unemulsified lipids and oils, which tend to float on aqueous solutions. Thus, in some embodiments, the opening (103) may be located at the center of the stopper, at the periphery of the stopper, or at any point in between (e.g., proximal to the periphery, proximal to the center).

In all stoppers of the present invention, the outlet conduit may be located in a recess that is hydrophobic. In such stoppers it is expected that more hydrophobic solute gathers at the recess and can be withdrawn, leaving the aqueous buffer in the container. Depending on its size, the outlet conduit (108) may permit the outlet rate of different amounts of fluid sample per second, depending on the sample. Furthermore, the size of the outlet conduit may be varied depending on the type of sample to be removed. Flow rate through an outlet conduit can also be affected by the viscosity of a sample (which is related to factors such as temperature, particle size and number and the presence or absence of any anti-coagulants or gelling agents). It will be apparent to one of skill in the art that the diameter of the outlet conduit may be optimized to produce the most efficient rate of flow through the outlet conduit.

Flow rates through an outlet conduit will typically be greater than zero, for example: 0.1, 0.2. 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10.0 nanoliters per second. Other, higher flow rates through an outlet conduit include, but are not limited to, 0.01 ul, 0.02 ul, 0.03 ul, 0.04, ul, 0.05 ul, 0.06 ul, 0.07 ul, 0.08 ul, 0.09 ul, 0.1 ul, 0.2 ul, 0.3 ul, 0.4 ul, 0.5 ul, 0.6 ul, 0.7 ul, 0.8 ul, 0.9 ul, 1 ul, 1.5 ul, 2 ul, 2.5 ul, 3 ul, 3.5 ul, 4 ul, 4.5 ul, 5 ul, 5.5 ul, 6 ul, 6.5 ul, 7 ul, 7.5 ul, 8 ul, 8.5 ul, 9 ul, 9.5 ul, 10 ul, 11 ul, 12 ul, 13 ul, 14 ul, 15 ul, 16 ul, 17 ul, 18 ul, 19 ul, 20 ul, 25 ul, 30 ul, 35 ul, 40 ul, 50 ul, 55 ul, 60 ul, 65 ul, 70 ul, 75 ul, 80 ul, 85 ul, 90 ul, 95 ul, or 100 ul, 125 ul, 150 ul, 175 ul, 200 ul, 350 ul, 300 ul, 350 ul, 450 ul, 500 ul, 550 ul, 600 ul, 650 ul 700 ul, 750 ul, 800 ul, 850 ul, 900 ul, 950 ul, or 1000 ul per second. One of skill in the art will readily recognize that flow through an outlet conduit need not be continuous or consistent. For example if a sample container is placed on a rocker, flow of sample through an outlet conduit will typically increase when the stopper is in a downward facing position. Additionally, where pumps or vacuums are utilized to facilitate sample withdrawal, those devices may be turned off and on, causing fluctuations in flow rates.

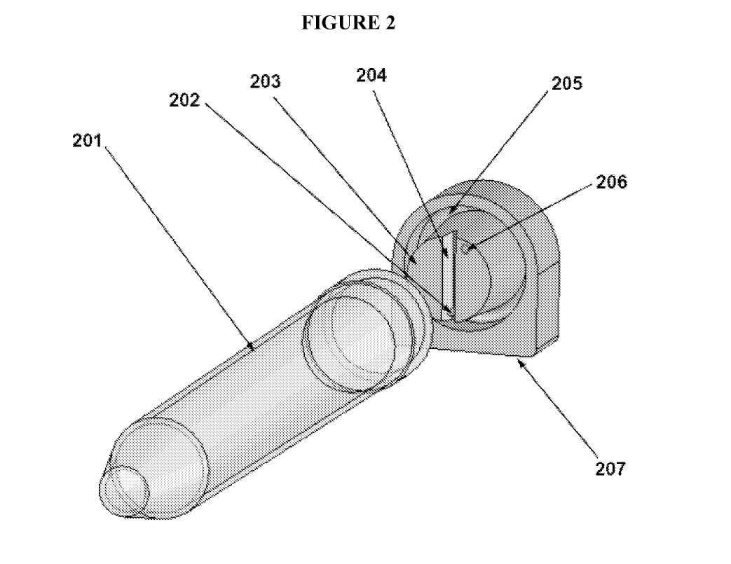

A second embodiment of the present invention is shown in FIG. 2. As in the previous embodiment, the stopper has a surface (203) which is internal to the tube or other container into which it is inserted. Internal openings of an outlet conduit (202) and an inlet conduit (206) are shown. As in the previous embodiment, the opening of the outlet conduit (202) lies within a recessed area (204) of the internal surface, whereas the opening of the inlet conduit (206) does not. An optional feature of any stopper of the present invention, an insertion depth stop (205), is shown. Such features prevent the stopper from being inserted too deeply into the sample container (201). One of skill in the art will recognize that an insertion depth stop will be configured to match both the stopper and the sample container and, thus, can be configured in many ways to achieve this goal.

Also shown in FIG. 2 is a flat surface (207) on a portion of the external portion of the stopper. The flat surface (207) is designed to orient the internal opening (202) of the outlet conduit and/or the recessed area (204). Thus, in this embodiment, the design of the stopper will allow the sample container to remain stationary when the flat surface (207) of the stopper is placed in contact with a corresponding flat surface (e.g. a platform rocker, a lab bench surface). The internal opening (202) of the outlet conduit will be oriented near the bottom of the sample container when the stopper is placed on a flat surface. This orientation is conducive to keeping the liquid sample in contact with the outlet conduit, preventing or lessening the chance of an air bubble entering the outlet conduit. One of skill in the art will recognize that a different orientation (e.g., outlet conduit is near the top of the sample container when placed on a flat surface) is achievable by placing the flat surface or other orientation-maintaining feature in a different position relative to the outlet conduit and/or recess.

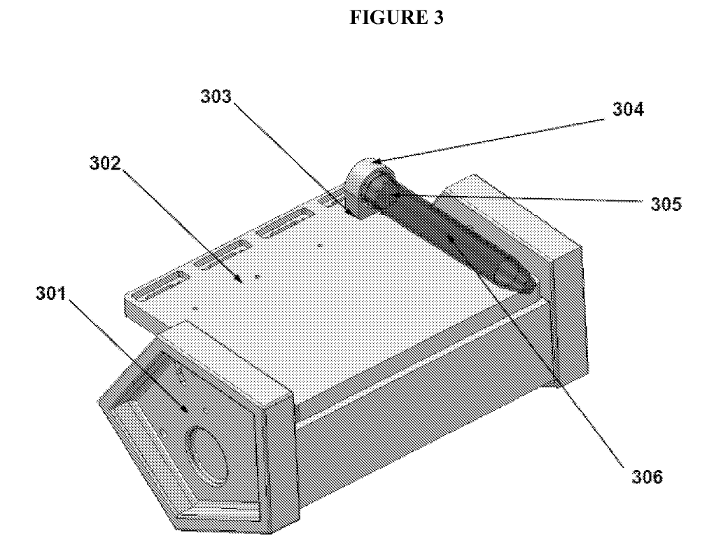

An embodiment with the stopper inserted in a sample tube placed on a rocker is shown in FIG. 3. In this embodiment, the stopper (304) is inserted into sample container (306) and placed on a rocker platform (302). The orientation-maintaining feature (303), a flat surface, lies directly against the surface of the rocker platform (302). The stopper (304) is designed such that when the flat surface (303) is in contact with a corresponding flat surface, the recess (305) on the interior surface of the stopper (304) is maintained in a vertical position relative to the rocker platform.

When the rocker (301) is in motion, a liquid sample in the tube will be alternately moved by gravity to the stopper end and to the closed end of the sample container. The recess (305) is designed to retain a quantity of a sample being withdrawn to supply the outlet conduit during periods of non-submergence (e.g, a sample tube is stored with the stopper up or the sample tube is placed on a mechanical rocker). In one embodiment the recess retains a quantity of sample by hydrophobic or hydrophilic interactions between the surface of the recess and the sample. In another embodiment the recess retains a quantity of sample by van der Waals forces or by hydrogen bonding. Whether an individual recess is hydrophobic or hydrophilic will depend on the purpose to which the stopper is put, the material from which the recess of the stopper is made, and/or treatment of the recess with a hydrophilicity-affecting agent. Thus, the stoppers of the present invention prevent or limit access of air into the outlet conduit when the majority of a fluid sample (e.g., blood) is not in contact with the interior surface of the stopper.

Thus, the stoppers of the present invention, while being useful for most applications, are particularly useful when they are used in conjunction with a rocking platform, or other motion-inducing technology. In such applications, it is likely that the sample within the container will be intermittently in contact with the interior surface of the stopper, and thus the recess (305) in which the internal opening to the outlet conduit is located. Such intermittent contact may arise from several sources, including, but not limited to, a rocking motion causing the liquid sample to approach and draw away from the surface of the stopper interior to a sample container and/or decrease in volume of liquid sample within the sample container upon outlet of the sample through the outlet conduit.

Without being bound by theory, typically, when the liquid or fluid is not covering the bottom surface of the stopper, the outlet conduit is uncovered and air can be drawn into the conduit. The presence of a recess (305) on a surface of the stopper may hold a small quantity of liquid. This is especially true when the interior surface, the recess, and/or the surface immediately surrounding the outlet conduit opening are hydrophilic or hydrophobic (to match the hydrophilicity characteristics of the sample). Thus, for example, the presence of a hydrophilic recess would tend to attract and retain hydrophilic liquid in the recess and near the outlet conduit when the majority of the liquid is out of contact with the interior surface of the stopper that is interior to the sample container. The recess (305) in this embodiment thus retains a sufficient quantity of liquid, substantially preventing air from entering the outlet conduit by way of the sample container.

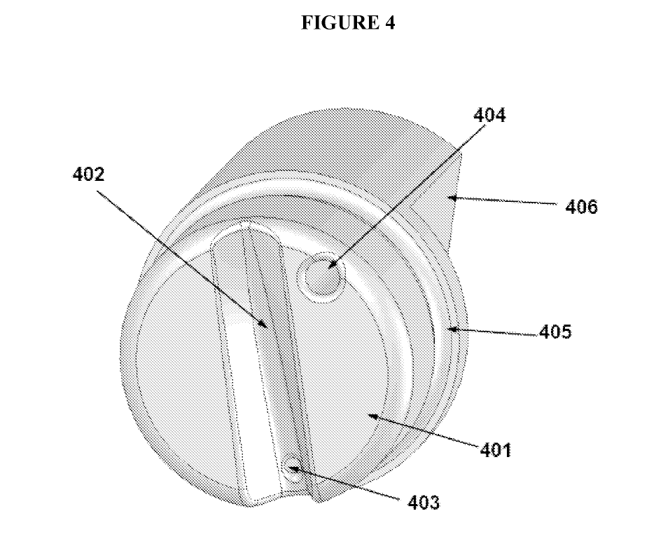

A more detailed graphic focusing on the portion of a stopper of the present invention is shown in FIG. 4. This figure shows the “bottom” surface of a stopper, or the surface intended to be interior to a sample container when inserted into the container. As in previous figures, shown here are an interior surface (401), an inlet conduit (404), a recessed area (402) and an outlet conduit (403). This figure shows that the recessed area (402) may have different internal structures. As demonstrated in FIG. 4, the recessed area (402) may completely surround the outlet conduit (403). Additionally, the width of the recess may change along the length of the recess. Furthermore, the floor of the recess (402) may have a slope wherein one end of the recess is located at a greater depth from the bottom surface (401) of the stopper than the other end of the recess. Additionally, the outlet conduit is typically located at the deepest region of the floor of the recess. In another embodiment, the floor of the recess may be narrower at one end of the recess than at the other end of the recess (402).

The recess (402) may be located along the entire diameter of the bottom surface and may narrow or widen along its length. For example, the widening or narrowing of the recess may be at least 25%, 26,%, 27%, 28%, 29%, 30%, 31%, 32%, 33%, 34%, 35%, 36,%, 37%, 38%, 39%, 40%, 41%, 42%, 43%, 44%, 45%, 46,%, 47%, 48%, 49%, 50%, 51%, 52%, 53%, 54%, 55%, 56,%, 57%, 58%, 59%, 60%, 61%, 62%, 63%, 64%, 65%, 66,%, 67%, 68%, 69%, 70%, 71%, 72%, 73%, 74%, 75%, 76,%, 77%, 78%, 79%, 80%, 81%, 82%, 83%, 84%, 85%, 86,%, 87%, 88%, 89%, 90%, 91%, 92%, 93%, 94%, 95%, 96,%, 97%, 98%, 99%, 100% of the length of the recess. The length of the recess (402) may be the diameter of the stopper if the bottom surface of the stopper is circular, for example, the recess may be at least 25%, 26,%, 27%, 28%, 29%, 30%, 31%, 32%, 33%, 34%, 35%, 36,%, 37%, 38%, 39%, 40%, 41%, 42%, 43%, 44%, 45%, 46,%, 47%, 48%, 49%, 50%, 51%, 52%, 53%, 54%, 55%, 56,%, 57%, 58%, 59%, 60%, 61%, 62%, 63%, 64%, 65%, 66,%, 67%, 68%, 69%, 70%, 71%, 72%, 73%, 74%, 75%, 76,%, 77%, 78%, 79%, 80%, 81%, 82%, 83%, 84%, 85%, 86,%, 87%, 88%, 89%, 90%, 91%, 92%, 93%, 94%, 95%, 96,%, 97%, 98%, 99%, 100% of the diameter of the bottom surface of the stopper.

Any of the interior surfaces of the stoppers of the invention may vary in hydrophilicity or hydrophobicity from other surfaces. Additionally, portions of the interior surfaces (i.e. those expected to be exposed to the interior of a sample container) may differ in hydrophilicity characteristics from other portions of the interior surface. For example, the interior surface (401) may be hydrophilic whereas the recessed area (402), or a portion thereof, is hydrophobic, or vice versa. Typically such variation in hydrophilicity will be present on the surface (401), recessed (402), and/or internal opening of the internal conduit (403)—portions of the stopper intended to be interior to the sample container and, thus, likely to come into contact with the sample. In another embodiment the stopper may comprise one or more conduits, wherein the conduits may further comprise a liner that has different properties than the properties of other regions of the stopper, such properties include but are not limited to, color, porosity, pH, hydrophobicity, hydrophilicity, strength, flexibility, and anti-bacterial qualities.

Also shown in FIG. 4 is a ring (405) which may be present on a stopper of the invention. Generally, the function of such a ring is to seal the edges of the stopper to the sample container (e.g. a test tube) into which it is inserted. Such a design feature may be present in any stopper of the invention, but is of particular use in embodiments where the sample is to be kept sterile and/or a gas is introduced into the sample container, for example, through an inlet conduit (404). The gas introduced may be atmospheric air, or any other gas or mixture of gases, including, but not limited to, nitrogen, CO₂, oxygen, oxygen-nitrogen mixtures, helium, and helium-oxygen mixtures.

In the embodiment shown in FIG. 4, the recessed area (402) is designed so that a fluid sample drains to an outlet conduit (403) located at one end of the recess. The recess (402) is a hydrophilic recess to increase the attraction of a hydrophilic sample to remain at the outlet conduit. Alternately, the recess may be hydrophobic if the sample, or a portion of interest thereof, is hydrophobic. In some applications all surfaces intended to be interior to the sample container will be hydrophilic (or hydrophobic). In such instances, orientation of the sample container may help insure more constant contact of liquid retained within the recess with the outlet conduit. Thus, the sample container and stopper are typically maintained in a position where the recess (402) is horizontal to the plane of gravity. Such position maintenance increases the likelihood that liquid will remain in the recess than would be the case where the recess were perpendicular to the plane of gravity. Such orientation may be maintained by constructing the stopper with an orientation-maintaining feature (406).

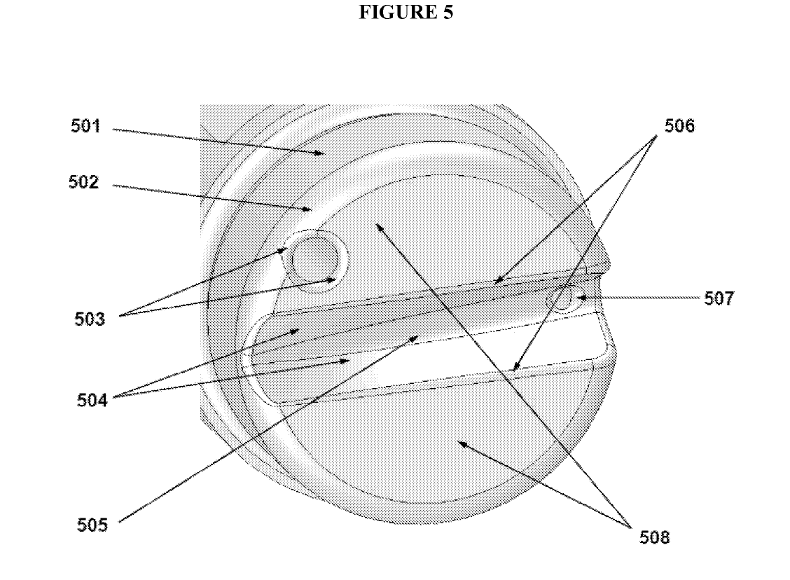

A more detailed version of the interior surfaces of one embodiment of a stopper of the present invention is shown in FIG. 5. Shown here are all surfaces which are internal to the sample container when the stopper of this embodiment is inserted. The first surface is the side surface (501). The side surface may form a tight seal against the interior walls of a sample container, depending on the dimensions of the container and/or the design of the stopper. The next surface is the transitional surface (502) which is located between the side surface (501) and the bottom surface (508). In this embodiment, the transitional surface is rounded; however, one of skill in the art will recognize that such a surface may be of any configuration appropriate to the design of the sample container and/or the stopper. The next surface is the rim (503) of the inlet conduit. This surface is typically the area immediately surrounding the inlet conduit. In some embodiments, this area is indistinguishable from the bottom surface (509).

In this embodiment, the recess-side surfaces (504), are the portions of the recessed area which form the walls of the recess. In this embodiment, these surfaces are sloped; however, one of skill in the art will recognize that many configurations are possible, depending on factors including, but not limited to, position of the outlet conduit, sample characteristics. Also shown is the recess-floor surface (505) which forms a relatively flat surface in the recess. In some embodiments, the recess-floor surface is not present (e.g., where the recess walls form a “V” shape). The recess-side surfaces (504) may be bounded by a recess-transition surface (506), which forms the boundary between the recess and all other surfaces which the recess contacts. In the embodiment shown in FIG. 5, the recess-transition surface contacts the transitional surface (502), the bottom surface (508), and the side surface (501). In other embodiments, other surfaces may be in contact with the recess-transition surface and/or the recess-transition surface may not be clearly delineated. Also shown is the rim (503) of the outlet conduit. This surface is typically the area immediately surrounding the inlet conduit. In some embodiments, this area is indistinguishable from the recess-floor surface (505).

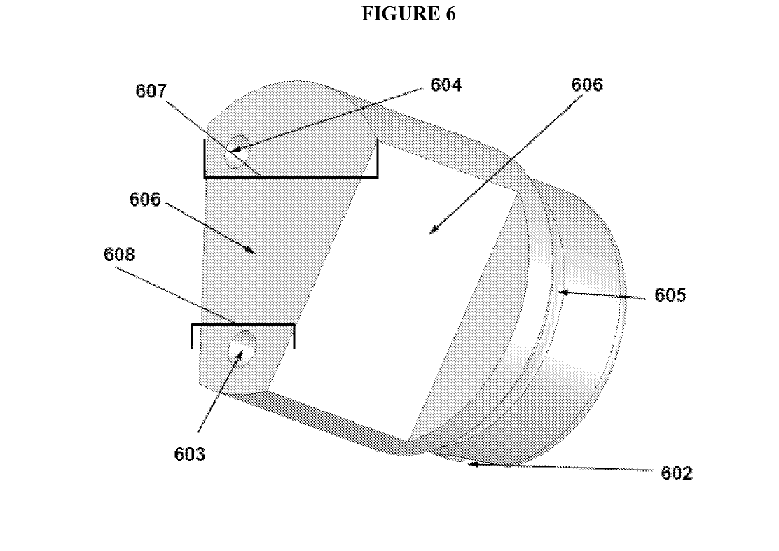

In another embodiment (FIG. 6), the stoppers of the present invention have an orientation-maintaining feature (606) designed for a particular compatible system which may be used to orient the stopper. This feature (606) may correspond to a feature on a sample rack, sample rocker, or other device such that placement of the sample tube on the rack, rocker or other device will serve to maintain the position of the sample container. In other embodiments, the device (e.g., sample rocker) may contain complementary indentations, protuberances or other features which, in combination with the orientation-maintaining feature (606) serve to orient the stopper and/or sample container. Additionally, the top surface of the stopper (607) may have an asymmetric shape with a wider end (609) and a narrower end (608). Such a configuration may be utilized to position the stopper into a rack or other holding device with a complementary shape to ensure positional maintenance of the stopper and sample container. As described above, such positional maintenance may serve to enhance (or discourage) liquid retention in a recessed area (602) on the bottom surface of the stopper.

Features on the exterior parts of the stopper (606, 608, 609), alone or in combination, may serve to hold a sample container in a desired position. In other embodiments the exterior portions of a cap surface may contain a protrusion or extension of the stopper, an asymmetric shaped stopper (such as wherein one end of the stopper is squared on one side and round on the other), and/or a separate component attached to the stopper, which may be inserted or connected to another device to maintain a specific orientation, such as upright, for the stopper and the sample container. The features serving as an orientation holder may attach to, or insert into, a device or receptacle.

The feature(s) for orientation (606, 608, 609) may also be used to orient the stopper and sample container in a device for processing the sample contained within the sample container. For example, in some embodiments where the stopper contains both an outlet conduit (603) and an inlet conduit (604) proper orientation may be necessary to align the conduits in a device or receptacle. Examples of such devices have already been described.

As described for other embodiments, the recessed area (602) typically surrounds all or a portion of the outlet conduit (603) on the surface of the stopper intended to be interior to the sample container, and therefore in contact with the sample. The liquid or fluid sample may gather at the recess, due to multiple causes, including, for example, sample volume and/or placement of the container on a flat surface such that the liquid redistributes from one end of the container. The recessed area (602) may be a spot or area surrounding the outlet conduit (603) and may be shaped as a notch, slot, groove, channel, or reservoir, or may have more complex geometries that tend to gather liquid, such as multiple slots or notches. Furthermore, the interior surfaces of any recessed area may be further textured to provide more surface area to hold more sample volume. For example, recessed areas of the present invention may be capable of retaining several milliliters of sample. In another embodiment, the recess may be any shape or pattern, such as circular, square, triangular, rectangular, or star shaped pattern. In another embodiment, the recess may have tapered walls that are farther apart at the top of the recess than at the floor of the recess. In other instances, the interior surface of the stopper may have multiple recessed areas, allowing for retention of larger volumes of sample (e.g., the interior surface has multiple parallel grooves giving the interior surface a “pleated” appearance).

In some instances, portions of the stopper external to the sample container may be inserted into a device. The configuration of the stopper may be complementary to the device, such that when inserted, the position of the sample container is maintained. For example, the shape of the stopper illustrated in FIG. 6, would correspond to a device into which the stopper would be inserted. This device may serve multiple functions (e.g., sample analysis, air pump) but would typically be distinct from the sample container into which the opposite end of the stopper would be inserted. Additionally, the configuration of the stopper and the device may help to align tubes or other features which may insert into, or extend from the outlet conduit (603) and/or the inlet conduit (604).

In one embodiment the top of the top of the stopper (606) has an asymmetric shape, wherein one side of the top is narrow (608) and the other side of the top of the stopper is broader (607). In such embodiments an opening or receptive part of a device is typically designed in such a manner such that the stopper will fit into the opening in a single orientation. Such embodiments prevent the outlet conduit from being in the wrong orientation, or being connected to the wrong tube, such as an inlet tube.

Examples of the types of devices or receptacles into which the stoppers of the present invention may be placed, include a shaker or rocker, such as Barnstead Speci-Mix (Fisher Scientific) or Unico Rock-It Jr. (Unico). Such devices may prevent unwanted separating or sedimenting within the sample, and the stopper and container may be oriented to maintain shaking in a certain orientation (e.g., rocking will cause the liquid to travel from the bottom of a test tube to the top). Thus, the orientation holder may prevent the stopper and its associated sample container from being oriented incorrectly. In some embodiments, the stopper comprises an inlet conduit/tube that passively delivers air at neutral pressure to the sample container. In an alternative embodiment an inlet conduit/tube delivers air under positive pressure to the sample container. In another embodiment the stopper comprises an intake conduit, which delivers reagents or diluents to the sample container.

A rocker or shaker may comprise an opening that will only fit a stopper in a single orientation. Alternately, the rocker or shaker may comprise a sensor that notifies a user when a stopper is not properly inserted or is incorrectly oriented into the opening of the device or receptacle. The sensor may comprise an optical sensor (including but not limited to a visual light sensor or an infrared sensor), a pressure sensor or a magnetic sensor. Notification to a user may be communicated via a graphical display, a warning light (such as a flashing light), an auditory warning (such as a buzzer or bell), a vibratory warning or any combination thereof.

### EXAMPLES

### Example 1

### Stopper for Blood Sample in Vacutainer

A rubber stopper with a tube for outlet of blood is inserted into a Vacutainer (Becton Dickinson) blood tube. The bottom surface of the rubber stopper, or inside surface, is the surface located within the blood tube. A recess in the inside flat surface of the stopper is rendered hydrophilic to the blood by treatment of the stopper with ionized plasma. A conduit present in the recess of the stopper is used to withdraw the blood at a few microliters per second rate. A second conduit is present in the stopper to vent to the atmosphere to prevent the Vacutainer from being a lower pressure than atmospheric pressure.

The Vacutainer is placed on a rocker such as a Barnstead Speci-Mix (Fisher Scientific) or Unico Rock-It Jr. (Unico). The rocking prevents the blood components from separating. The rocker places the Vacutainer in an essentially horizontal position (see, for example, FIG. 3). The Vacutainer-stopper combination is oriented with the outlet tube in the down most position and with the recess in a vertical orientation. The top of the rubber stopper is asymmetrical, containing a flat-edged protuberance. When placed on the flat surface of the Barnstead Speci-Mix, the protuberance maintains the Vacutainer in place, thus maintaining the orientation of the outlet tube in the down position during rocking. Rocking causes the blood to flow between the stopper end and the bottom end of the Vacutainer.

Occasionally, especially when the tube is near empty, the stopper is above the blood level when the blood runs to the bottom end of the tube. Normally, when the blood is not covering the stopper, the outlet tube is also uncovered and air is drawn into the outlet tube. However, the hydrophilic recess on the stopper will hold a small quantity of blood in the notch while the blood is not covering the stopper. As blood continues to be withdrawn by the outlet tube, the recess retains a sufficient quantity of blood, preventing air from entering the outlet tube. The recess is oriented in a vertical position so that when the rocker is returned to the stopper end down orientation and blood covers the stopper, air bubbles are likely to be excluded from the hydrophilic region.

### Example 2

### Stopper for Hydrophobic Sample

A rubber stopper comprising an outlet conduit and an inlet conduit with a tube for outlet of the sample is inserted into a sample tube. The bottom surface of the rubber stopper, or inside surface, is the surface located within the sample tube. A recess in the bottom surface of the stopper is rendered hydrophobic to non-aqueous fluids or components, such as oils or lipids. This can be done by the addition of hydrophobic compounds to the stopper material during manufacture, or by coating the bottom of the stopper with a layer of hydrophobic material after manufacture. A conduit present in the recess of the stopper is used to withdraw the oil at a few microliters per second rate. A second conduit is present in the stopper to vent to the atmosphere to prevent the sample tube from being a lower pressure than atmospheric pressure.

The sample tube is placed on a rocker such as a Barnstead Speci-Mix (Fisher Scientific) or Unico Rock-It Jr. (Unico). The rocking may assist in accumulation of hydrophobic particles or droplets from a uniform solution wherein the components are evenly mixed, for example, a salt water sample suspected of contamination with oil. The rocker places the sample container in an essentially horizontal position. The sample container and stopper are oriented with the outlet conduit in the up most position (because the oil is expected to float on the aqueous solution) and with the recess in a vertical orientation. The rocker has grooved holders into which the grooved rubber stoppers fit. The fit between the grooved holder and the grooved rubber stopper maintains the position of the stopper and, therefore the sample tube, during the sample withdrawal.

Rocking causes the sample to flow between the stopper end and the bottom end of the sample container. Occasionally during the rocking, the outlet conduit of the stopper will be above the sample level as the sample container empties and when the sample migrates to the bottom end of the tube. The hydrophobic recess on the stopper holds a small quantity of sample in the recess when the sample is not covering the stopper. As the sample is withdrawn into the outlet conduit, the recess retains a sufficient quantity of sample to essentially prevent air from entering the outlet tube. In this embodiment, the hydrophobic recess may also retain sufficient quantity of the hydrophobic portion of the sample to essentially exclude the aqueous solution from the withdrawal tube. The recess is oriented in a vertical position so that when the rocker is returned to the stopper end down orientation and the sample covers the stopper, air bubbles are excluded from the hydrophobic region

The present invention is not limited to the embodiments described above, but is capable of modification within the scope of the appended claims. Those skilled in the art will recognize, or be able to ascertain using no more than routine experimentation, many equivalents of the specific embodiments of the invention described herein.

1. A stopper for a container for liquids comprising:
a) a top surface and a bottom surface, wherein said bottom surface comprises a recessed area that is hydrophilic or hydrophobic; and
b) a first conduit that extends from said top surface to said recessed area.

2. The stopper of claim 1, wherein said first conduit is configured for a outlet rate of at least 0.01 μl per second.

3. The stopper of claim 1, wherein said recessed area is at least 25% length of the stopper diameter.

4. The stopper of claim 1, further comprising an orientation-maintaining feature located on said top surface.

5. The stopper of claim 4, wherein said orientation-maintaining feature maintains said recessed area in a vertical position when placed on a flat surface.

6. The stopper of claim 1, further comprising an air-tight seal.

7. The stopper of claim 1, further comprising a second conduit that extends from said top surface to said bottom surface.

8. The stopper of claim 7, wherein said second conduit extends to an area of said bottom surface not within said recessed area.

9. The stopper of claim 7, wherein said second conduit is connected to a pump.

10. The stopper of claim 7, wherein a gas enters said container through said second conduit.

11. (canceled)

12. The stopper of claim 1, wherein said first conduit comprises an interior surface which is hydrophobic or hydrophilic.

13. The stopper of claim 1, further comprising a tube fluidly connected with said first conduit, wherein said tube does not extend into said container further than said recessed area.

14. The stopper of claim 1, wherein said first conduit is proximal to the periphery of the stopper.

15. The stopper of claim 1, wherein said first conduit is connected to a vacuum.

16. A method of withdrawing a sample from a sample container comprising the steps of:
a) placing a stopper in said sample container comprising:
i) a top surface and a bottom surface, wherein said bottom surface comprises a recessed area that is hydrophilic or hydrophobic; and
ii) a first conduit that extends from said top surface to said recessed area; and
b) limiting access of air into said first conduit in said stopper by maintaining liquid at said first conduit on said bottom surface.

17. The method of claim 16, wherein said limiting step is enhanced by hydrophilic or hydrophobic attraction between said recessed area and said liquid.

18. The method of claim 16, wherein said stopper further comprises a second conduit that extends from said top surface to said bottom surface.

19. The method of claim 18, wherein a gas is inserted through said second conduit.

20-27. (canceled)

28. A method of withdrawing a sample from a sample container comprising the steps of:
a) placing a stopper in said sample container comprising:
i) a top surface and a bottom surface, wherein said bottom surface comprises a recessed area that is hydrophilic or hydrophobic;
ii) a first conduit that extends from said top surface to said recessed area; and
b) placing said sample container on a rocker, wherein said rocker is capable of causing at least a portion of said sample to be drawn away from said stopper by gravity; and
c) limiting access of air into said first conduit in said stopper by maintaining liquid at said first conduit on said bottom surface.

29. The method of claim 28, wherein said limiting step is enhanced by hydrophilic or hydrophobic attraction between said recessed area and said liquid.

30-40. (canceled)
